(19) United States
(12) Patent Application Publication
(10) Pub. No.: US 2013/0086869 A1
(43) Pub. Date: Apr. 11, 2013

(54) Method of Mounting Tiles With a Foam-Backed Adhesive and Apparatus

(71) Applicant: AMBEL GROUP, INC., North Palm Beach, FL (US)

(72) Inventor: Marysusan Couturier, Framingham, MA (US)

(73) Assignee: AMBEL GROUP, INC., North Palm Beach, FL (US)

(21) Appl. No.: 13/645,690

(22) Filed: Oct. 5, 2012

Related U.S. Application Data
(60) Provisional application No. 61/544,398, filed on Oct. 7, 2011.

(51) Int. Cl. C09J 7/02; B32B 33/00; B32B 7/02; E04F 13/00; B32B 7/12

(52) U.S. Cl. 52/746.1; 428/317.3; 428/214; 428/41.8

(57) ABSTRACT

The present invention is directed to a method of applying a rigid tile to a tiling substrate, particularly a vertical tiling substrate, such as a wall, by utilizing a double-sided pressure sensitive adhesive (psa) membrane comprising a polyolefin foam carrier coated on each side with a pressure sensitive adhesive and an associated apparatus. The polyolefin foam carrier preferably has a compression strength between 7 and 20 psi (48.3 and 137.9 kPa) @ 25%. The adhesive coated foam can be supplied in a roll form, pre-applied to the back of the tile, or pre-applied to the tiling substrate. Preferably the psa is an acrylic psa.

### CROSS-REFERENCE TO RELATED APPLICATIONS

The priority of U.S. Provisional Patent Application No. 61/544,398, filed Oct. 7, 2011, is hereby claimed and the specifications thereof are incorporated herein by reference.

### STATEMENT REGARDING FEDERALLY SPONSORED RESEARCH

Not applicable.

### BACKGROUND OF THE INVENTION

1. Field of Invention

The present invention generally relates to methods and apparati for installing tiles. More particularly, the present invention is directed to a method of mounting tiles to a substrate with a foam-backed pressure sensitive adhesive and an associated apparatus.

2. Description of the Related Art

Construction materials such as natural tiles and the like, particularly ceramic tiles, are typically affixed to substrates such as walls, ceiling and floors, with an adhesive. One conventional method to adhere a tile to a substrate is to apply adhesive to the substrate, place the tile on top of the adhesive and wait a given period of time for the adhesive to dry. The oldest form of adhesive still used widely today is based on cement. Various types of cement-based mortars and thin-sets are well-known in the art. However, all of these cement-based products have major drawbacks, such as having to mix liquid and dry components, messy application, need of respirator, time consuming, and weight of materials, along with the time constraints of having to wait at least 24 hours prior to grouting. Organic adhesives, more commonly referred to as mastics, are also used to adhere tiles to a substrate. These are typically based on acrylic emulsions, e.g., as described in EP 0626397. While mastics generally do not require premixing, they still need to be troweled onto the substrate and one needs to wait a minimum of 24 hours to grout to allow time for the water to evaporate.

To eliminate the need of troweling, US 2009/0233034 describes an application system in which the tile adhesive is pre-applied in a grooved fashion to a backing sheet. After removal of a release liner to expose the adhesive, the backing sheet is pressed against the surface to be tiled, then peeled away, leaving the adhesive on the surface. EP 0001881 describes a process to make a self-adhesive tile wherein the back of the tile is coated with a mixture of cement, adhesive, water or solvent and then the liquid is dried. Prior to application of the tile, it is immersed or dipped in water to turn the cement into a paste.

The use of a pressure sensitive adhesive to affix tiles to a substrate may overcome some of the drawbacks of using thin set and mortars. However, not all pressure sensitive adhesives are suitable for this application. The type of adhesive, thickness and construction play an important part in maintaining the tile for a prolonged period of time. Ideally, the adhesive should not have any strong odors, should be stable against oxidation and should not have any components that bleed out as this will affect the long term durability of the tile/adhesive bond.

There are many different types of tiles that are used in interior of buildings, such as ceramic, glass, marble, quarry for example. The size, type and intended use of the tile can have large effects on the adhesive requirements. For example, floor tiles require structural support to prevent the tile from cracking due to flexing. However, tile for vertical applications do not have this requirement, but the weight of tiles can vary greatly depending on its density and size. Glass mosaic can be as small as 1.2 cm×1.2 cm and weigh as little as 1.5 grams. On the other hand, a 30 cm×30 cm marble tile may weigh as much as 2.3 kg. In addition, the back of the tile may be uneven, which may result in higher stresses being applied to the adhesive if it does not make full contact. For example, most porcelain tiles have a ribbed or patterned surface on the back and the depth of these patterns can be as much as 0.18 cm. Given the large variety of tiles, it would be desirable to have a tile adhesive that could handle this diversity without being limited to the size or weight of tile that can be used.

GB 722,235 describes a two-sided adhesive material for attaching a ceramic or glass plate to a wall. The adhesive material is a carrier, such as a flexible web, coated on both sides with an adhesive, which remains lastingly plastic. The adhesive material may be first applied to the plate and the plate attached to the wall, or it may be first applied to the wall and then the plate applied to it. GB 2347893 describes the use of a composite membrane to adhere tiles. The membrane consists of a thermoplastic adhesive with a mesh embedded in the surface. The adhesive may be based on butyl rubber, bitumen or styrenic block copolymer. Thermoplastic butyls suffer from poor load bearing capacity and long term creep. Most styrenic block copolymers suffer from oxidative degradation. Bitumen-based products typically suffer from odor and oil bleed.

EP 1044797 describes a method for mounting ceramic tiles by means of an acrylic foam pressure sensitive adhesive. However, this application is for temporary application of the tiles, such as store displays, and is not meant to be permanent. While this patent suggests that the tiles are firmly mounted, it also indicates they can be cleanly removed as desired. The risk of using a temporary adhesive for permanent applications is that the tiles could fall off. It is also doubtful that the acrylic foam adhesive would have sufficient strength to hold heavy tiles on a vertical surface.

U.S. Pat. No. 3,962,504 describes a self-attaching ceramic tile comprising equidistant ribs of adhesive covered with a peel-off film. However, incomplete application of adhesive on the back surface of the tile may form channels where water can get trapped behind the tile and form mold. Tiles used on shower walls and countertops would be particularly susceptible to this. Thus, it would be desirable to have a continuous layer of adhesive over the tile. U.S. Pat. No. 5,362,560 describes a rigid floor tile which comprises a flexible grout applied to the sides of the tile and a foam and adhesive applied to the underside of the tile. Part of the adhesive is dusted with powder to minimize the tile from sticking on application. Although this may ease application, it would cause poor adhesion to the floor in the dusted area, which may result in tile cracking.

While other methods of using a pressure sensitive adhesive to apply rigid tiles to walls exist, they all suffer from the limitations of tile size or weight, and the need to grout with a given time frame to provide structural support as the adhesive is not strong enough. For example, Bondera® TileMatSet is a butyl based adhesive mat, but this mat cannot be used for tiles larger than 15 cm×15 cm and the tiles must be grouted within 24 hours. Simple Mat® tile setting mat consists of ribs of a synthetic adhesive applied to one side of a non-woven mat and the other side has a very thin layer of synthetic adhesive. This product has tiles size limitations of 20 cm×20 cm and also must be grouted within 24 hours. Incomplete application of the adhesive can lead to voids where water can become trapped behind the tile. Tile Quick™ consists of a floor padding layer covered on both sides with an acrylic adhesive. It has tile weight limits of 1.6 kg and must be grouted immediately. DIY backsplash kit consists of 1.2 cm square mosaic tiles pre-applied to acrylic coated foam. The tile size is very small and it must be grouted within 2 hours of application.

### SUMMARY OF THE INVENTION

The present invention is directed to a method of applying a rigid tile to a tiling substrate, particularly a vertical tiling substrate, such as a wall, by utilizing a double-sided pressure sensitive adhesive (psa) membrane comprising a polyolefin foam carrier coated on each side with a pressure sensitive adhesive. The polyolefin foam carrier preferably has a compression strength between 7 and 20 psi {48.3 and 137.9 kPa) @ 25%. The adhesive coated foam can be supplied in a roll form, pre-applied to the back of the tile, or pre-applied to the tiling substrate (e.g., wall board). Preferably the psa is an acrylic psa. In addition, it is preferable that the psa thickness is greater on one side (i.e., the tile side) of the foam carrier than on the other side (i.e., the wall side) of the foam carrier. This allows for increased contact and adhesion strength to the tile. The use of a double-sided psa-coated polyolefin foam for applying rigid tiles to walls eliminates the need to grout within 24 hours and allows the consumer to use tiles up to about 30 cm×30 cm in size.

Additional aspects, advantages, and embodiments of the invention will become apparent to those skilled in the art from the following description of the various embodiments and related drawings.

### BRIEF DESCRIPTION OF THE DRAWINGS

So that the manner in which the described features, advantages, and objects of the invention, as well as others which will become apparent are attained and can be understood in detail; more particular description of the invention briefly summarized above may be had by referring to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is an illustration of a side view of an embodiment of the present invention after application to a wall and after application of tiles.

FIG. 2 is an illustration of an exploded view of an embodiment of the present invention prior to installation including the release liners.

### DESCRIPTION OF THE PREFERRED EMBODIMENT

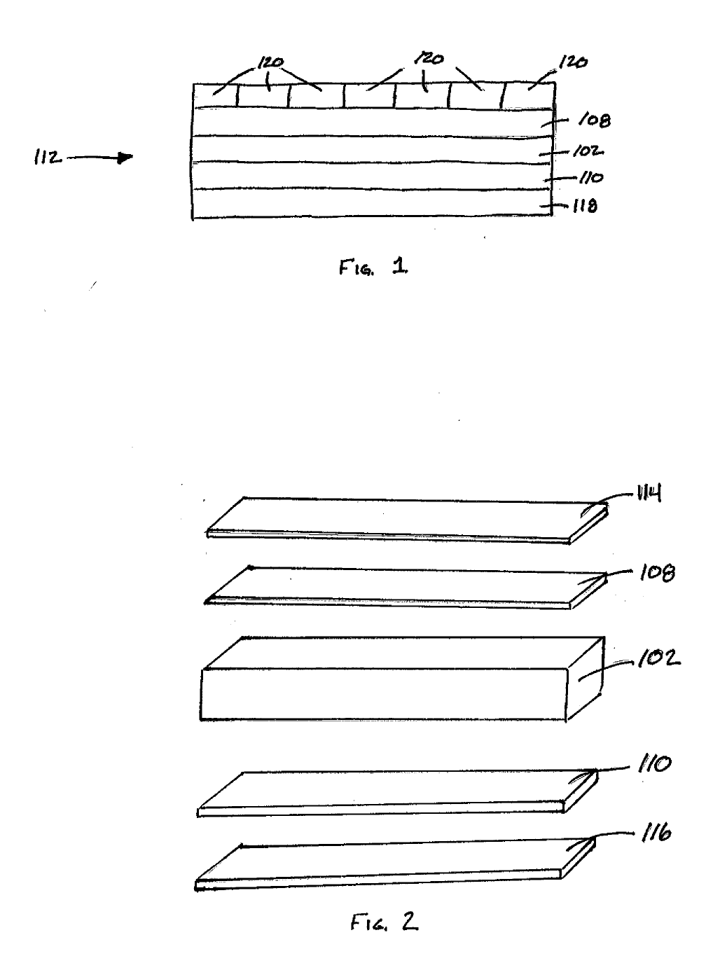

The present invention is directed to a method for adhering ceramic or other rigid tiles up to about 30 cm×30 cm (e.g., 15 cm to 30 cm×15 cm to 30 cm) in size to a tiling substrate, particularly a vertically oriented tiling substrate, such as a wall, without relying on grout to provide structural support and to an apparatus for use therein. The method includes providing an adhesive membrane 112 comprising a polyolefin foam carrier 102 having a first surface (i.e., the side) 204 and an opposite second surface (i.e., wall side) 206, wherein each of the first surface 204 and the second surface 206 are coated with a pressure sensitive adhesive (which may be the same or different psa on each surface) 108, 110; adhering the adhesive membrane 112 either to a tiling substrate or to the back surface of a tile 120 via the pressure sensitive adhesive 108, 110; and pressing the back surface of the tile 120 against the tiling substrate to adhere the tile 120 to the tiling substrate with the adhesive membrane 112 therebetween, resulting in the completed installation depicted in FIG. 1.

The pressure sensitive adhesive 108, 110 preferably is an acrylic pressure sensitive adhesive. The adhesive 108, 110 has to be soft enough to wet out the back of the tile 120 to provide good contact, but strong enough to hold the tile 120 in place. It is preferred to have a different adhesive amount 108, 110 on each side of the foam carrier 102. Since most tiles 120 have an uneven back surface, it is beneficial to have a higher amount of adhesive 108 on the tile side 204 of the adhesive membrane 112 to increase the contact area. Since the wall 118 is mostly even, a lower amount of adhesive 110 on the wall side 206 of the adhesive membrane 112 will be sufficient.

The thickness of the psa 108, 110 coated on the foam carrier 102 may be varied within wide limits, but should not be too thick to cause the adhered tile 120 to protrude too far from the surface of the wall 118 and should not be too thin to cause poor adhesion to the surface of the wall 118 or the tile 120. Preferably, the psa thickness on each surface 204, 206 of the foam carrier 102 may vary from 1.5 to 6.0 mils (0.0038 cm to 0.0152 cm). More preferably, the psa thickness on a first surface (i.e., the tile side) 204 of the foam carrier 102 will be about 2.5 to 6.0 mils (0.0063 cm to 0.0152 cm), and on a second surface (i.e., the wall side, which is the surface opposite the first surface 204) 206 of the foam carrier 102 will be about 1.5 to 3.5 mils (0.0038 cm to 0.0089 cm).

Acrylic pressure sensitive adhesives are widely known and are described in detail by Sata in Handbook of Pressure Sensitive Adhesives and by Temin in Encyclopedia of Polymer Science. Either solution or emulsion based acrylics can be used. If solution is used, the use of crosslinked adhesives would be preferable to increase shear strength and creep resistance. Examples of crosslinked acrylics can be found in U.S. Pat. No. 3,740,366, U.S. Pat. No. 3,900,610, U.S. Pat. No. 4,234,660 and U.S. Pat. No. 3,790,533. Either pure or modified acrylics may be used. Modifications may include tackifiers, rubbers, and plasticizers. If the adhesive is to be used in wet areas, such as shower, bath or kitchen, a crosslinkable acrylic psa would be beneficial. Suitable crosslinkable acrylic psa's are disclosed in US 2010/0120931, the disclosure of which is incorporated herein by reference. Particularly useful are monomers, oligomers or additives which crosslink in the presence of moisture.

The foam carrier 102 assists in providing contact with the tile 120 by compressing upon application of the tile 120. The type of foam used is important in achieving strength and conformability. In contrast with the acrylic foams described in EP 1044797 to achieve temporary adhesion with clean release of the tile and adhesive, the adhesive membrane of the present invention is intended to achieve strong, permanent adhesion. This is accomplished through the use of a polyolefin foam carrier. The term “polyolefin” is meant to include not only a homopolymer of an olefin, but also an olefin copolymer composed of at least 50 mole %, preferably at least 70 mole %, of at least one olefin unit and the remainder being another monomer copolymerizable with the olefin, and a blend of at least 50% by weight, preferably at least 60% by weight, of the olefin homopolymer or copolymer with another polymer. Examples of suitable olefins include ethylene, propylene, butylene, and hexene, and lower olefins having not more than 6, preferably not more than 4, carbon atoms. Examples of monomers copolymerizable with the olefin are vinyl acetate, vinyl chloride, acrylic acid and its esters, and methacrylic acid and its esters. Typical examples of the olefin resin that can be used include polyethylene, polypropylene, polybutylene, an ethylene/propylene copolymer, an ethylene/vinyl acetate copolymer, and an ethylene/vinyl chloride copolymer. They can be used either alone or as a blend of two or more such polymers or copolymers.

The other polymer that can be blended with the olefin homopolymer or copolymer may be any polymer compatible with it. Examples are polybutadiene, polyisoprene, polychloroprene, chlorinated polyethylene, polyvinyl chloride, a styrene/butadiene copolymer, a vinyl acetate/ethylene copolymer, an acrylonitrile/butadiene copolymer, a vinyl chloride/vinyl acetate copolymer, and butadiene copolymers. The use of polyolefin foams also provides the benefit of low moisture absorption and vapor transmission. Preferably the foam is fine cell and crosslinked with a density between 2 and 20 lb/ft³ (32 to 320 kg/m³).

The foam carrier will typically have a thickness of about 0.02 in (0.051 cm) to about 0.10 in (0.254 cm), preferably about 0.03 in (0.076 cm) to about 0.09 in (Q.23 cm).

If the adhesive foam membrane 112 is supplied in roll form, it will have one or more release liners 114, 116, as illustrated in exploded view in FIG. 2. If only one release liner 118 is used, it should be double coated so the adhesive 108, 110 does not stick to itself. If it has two release liners 114, 116, it is preferred that they have a different rate of release.

The present invention also encompasses a rigid tile 120, such as a ceramic, glass or stone tile, with a pre-applied adhesive foam membrane 112 as described. In addition, the present invention encompasses a tiling substrate, such as wall board or other construction material suitable for application of a rigid tile 120, with a pre-applied adhesive foam membrane 112 as described. Accordingly, the invention encompasses a construction substrate, wherein the construction substrate comprises a rigid tile 120 or a tiling substrate, the construction substrate having an adhesive membrane 112 adhered to a surface thereof; wherein the adhesive membrane 112 comprises a polyolefin foam carrier having a first surface 204 and an opposite second surface 206, wherein each of said first surface 204 and said second surface 206 are coated with a pressure sensitive adhesive 108, 110. In each of the foregoing pre-applied products, the exposed adhesive side of the membrane 112 is covered with a release liner 114, 116. Release liners for pressure sensitive adhesives are well-known in the industry. Sata in Handbook of Pressure Sensitive Adhesives describes the chemistry and technology of release liners.

The strength of the foam carrier is important. If the foam is too rigid, it will not allow sufficient compression. If the foam is too soft, it will tear, reducing the shear strength of the membrane 112. Preferably, the foam carrier will have at least two, more preferably at least three, and most preferably all four of the following properties (MD=machine direction; CD=cross direction):
Compression strength @ 25%: 7-20 psi (48.3-137.9 kPa) @ 25%. (ASTM D3575)
Tear resistance (MD): >20 lb/in (3.57 kg/cm), preferably 25-50 lb/in (4.5-9 kg/cm) (ASTM D 3575)
Tear resistance (CD): 17-36 lb/in (3-6.4 kg/cm)
Shore hardness A: 10-23

The industry standard test method for measuring shear strength of mastic tile adhesives is ANSI 136.1. This test is used to measure the strengths of the adhesive membranes of the present invention, but the standard test is modified to show adhesion strength of the tile to the tile substrate, rather than tile to tile as set out in the standard test.

### EXAMPLE 1

Adhesive membranes of varying psa thickness are tested for adhesive strength (shear strength). The adhesive membranes comprise a closed cell, crosslinked 0.03125″ (0.079 cm) polyethylene foam carrier coated on one side (the wall side) with 1.8 mils (0.0046 cm) of a solvent-based, crosslinked acrylic psa. The other side (the tile side) is coated with the same psa, but with different thicknesses, namely 1.8 mils (0.0046 cm), 2.5 mils (0.0063 cm) and 3.5 mils (0.0089 cm). The adhesive membranes are applied to paper faced gypsum wall board. The adhered membrane is rolled back and forth three times with a 5 lb (2.3 kg) roller to insure there is good contact with the wall surface. The release liner is removed and a 4.25 in (10.8 cm) square glazed ceramic wall tile placed on the exposed adhesive. The tile is rolled three times with a 5 lb (2,3 kg) roller. The test samples are allowed to sit at room temperature for 24 hours before being tested for shear strength according to ANSI 136.1 method. A minimum of three samples are tested for each thickness. Results for the three different psa thicknesses on the tile side of the polyethylene foam are shown in Table 1.

TABLE 1

| PSA Thickness (tile side) | Shear Strength psi (kpa) |
|---|---|
| 1.8 mils (0.0046 cm) | 37 (255) |
| 2.5 mils (0.0063 cm) | 41 (283) |
| 3.5 mils (0.0089 cm) | 46 (317) |

As can be seen from this test, increasing the adhesive thickness on the tile side greatly increases the shear strength of the system. The ANSI requirement for a tile mastic adhesive is 50 psi (344.7 kPa). The above-described membranes very nearly meet this requirement. Accordingly, it is preferred to utilize an adhesive membrane with a psa thickness of at least 3 mils (0.0076 cm) on the tile side.

### EXAMPLE 2

Adhesive membranes of varying foam thickness are tested for adhesive strength (shear strength). The adhesive membranes comprise a closed cell, crosslinked polyethylene foam carrier coated on one side (the wall side) with 1.8 mils (0.0046 cm) of a solvent-based, crosslinked acrylic psa and on the other side (the tile side) with 2.5 mils (0.0063 cm) of the same psa. Membranes with two different thicknesses of foam carrier are tested, namely 0.03125 in (0.079 cm) and 0.0625 in (0.159 cm). The adhesive membranes are applied to paper faced gypsum wall board. The adhered membrane is rolled back and forth three times with a 5 lb (2.3 kg) roller to insure there is good contact with the wall surface. The release liner is removed and a 4.25 in (10.8 cm) square glazed ceramic wall tile placed on the exposed adhesive. The tile is rolled three times with a 5 lb (2.3 kg) roller. The test samples are allowed to sit at room temperature for 24 hours before being tested for shear strength according to ANSI 136.1 method (modified to show tile to tile substrate adhesion). A minimum of three samples are tested for each thickness. Each set of test samples gave an average shear strength of 42 psi (289.6 kPa). This result suggests that varying foam thickness does not substantially affect the shear strength of the adhesive membrane when all other factors are the same.

Foams thinner than 0.03125 in (0.079 cm) may be adequate for small mosaic tiles with relatively flat backs. However, such thin foams may not be suitable for tiles with an uneven back surface. Conversely, foams thicker than 0.09375 in (0.238 cm) may not be suitable because such large thicknesses may cause the tile to protrude too far away from the wall surface, making it difficult to tie in connecting pieces.

### EXAMPLE 3

This example investigates the importance of the mechanical properties of the foam in achieving high adhesive strength to the tile and wall. To determine the optimum foam properties, samples of various crosslinked, closed cell polyolefin foam carriers were evaluated for shear strength (as previously described). The mechanical properties of three different foams (all are 0.03125 in (0.079 cm) thick) are shown in Table 2.

TABLE 2

| | Foam properties | | |
|---|---|---|---|
| | | 2 | 3 |
| | 1 | polyolefin | ethylene vinyl |
| Foam Type (0.079 cm) | Polyethylene¹ | alloy² | acetate³ |
| Compression Strength, | 12 psi | 8 psi | 6 psi |
| @ 25% | (82.7 kPa) | (55.2 kPa) | (41.4 kPa) |
| (ASTM D 3575) | | | |
| Tear resistance MD | 25 lb/in | 28 lb/in | 20 lb/in |
| (ASTM D 3575) | (4.5 kg/cm) | (5 kg/cm) | (3.6 kg/cm) |
| Tear resistance CD | 36 lb/in | 33 lb/in | 17 lb/in |
| (ASTM D 3575) | (6.4 kg/cm) | (5.9 kg/cm) | (3 kg/cm) |
| Shore A ( ASTM D 2240) | 23 | 15 | 10 |

¹Volara ® Type A
²Volara ® Type TS
³Volara ® Type EO

The shear strengths for adhesive membranes made with these foams are shown in Table 3.

TABLE 3

| Foam Type | 1 | 1 | 2 | 2 | 3 | 3 |
|---|---|---|---|---|---|---|
| PSA thickness wall side, mil | 2.4 | 2.4 | 2.4 | 2.4 | 2.4 | 2.4 |
| (cm) | (.0061) | (.0061) | (.0061) | (.0061) | (.0061) | (.0061) |
| PSA thickness tile side, mil | 3.6 | 5.2 | 3.6 | 5.2 | 3.6 | 5.2 |
| (cm) | (0.009) | (0.013) | (0.009) | (0.013) | (0.009) | (0.013) |
| Shear strength, psi (kPa) | 43.1 | 45.6 | 46.7 | 54.6 | 30.5 | 32.4 |
| | (297) | (314) | (322) | (376) | (210) | (223) |

As can be seen, and consistent with the previous example, increasing adhesive thickness on the tile side increases shear strength. However, the foam properties can also have an effect on shear strength. Foam 3, which is the softest foam, tore in the shear testing, resulting in lowering of the strength of the composite. Foam 2, which is in the middle in terms of strength, had the highest shear strength, actually passing the industry standard for tile mastics.

### EXAMPLE 4

This example compares the performance of the adhesive membrane of the present invention to some commercially available membranes. The products are tested against industry standards for strength. The shear strength is tested in accordance to ANSI 136.1, previously described. The heat resistance test is also under ANSI 136.1 and is used to assess the long term durability of the adhesive. The adhesive membrane ideally should be able to hold 10 lbs. (4.54 kg) in static shear for 24 hours at 120° F. (49° C.).

The pull-off test measures the force required to pull the tile perpendicular to the adhesive and is a good measure of how well the tile adheres to the substrate. The adhesive membranes were applied to paper faced gypsum wall board and rolled back and forth three times with a 5 lb (2.3 kg) roller to make good contact with the wall surface. The release liner is removed and a 4.25 in (10.8 cm) square glazed ceramic wall tile placed on the adhesive, then rolled three times with a 5 lb (2.3 kg) roller. A fixture that will allow the tile to be pulled off horizontally in an Instron machine in tension mode is adhered with epoxy to the center of the top of the tile and allowed to cure for 24 hours. The wall board is then clamped to the bottom platen on the Instron machine and the moveable jaw attached to the fixture on the tile. The cross head speed was 2″/min (5.1 cm/min) and the maximum load to remove the tile recorded. The results are shown in Table 4.

TABLE 4

| | | Tile | Simple | DIY | | Foam 2 |
|---|---|---|---|---|---|---|
| Test | Method | Quick | Mat | Backsplash | Bondera | (2.4/5.2 psa) |
| Shear Strength, psi | ANSI 136.1 | 9.4 | 12.7 | 10.2 | 5.9 | 54.6 |
| (kPa) | | (64.8) | (87.6) | (70.3) | (40.7) | (376.4) |
| Heat Resistance | ANSI 136.1 | Fail | Fail | Fail | Fail | Pass |
| Pull Off strength, psi | As | 4.4 | 1.5 | 5.0 | 2.2 | >9 |
| (kPa) | described | (30.3) | (10.3) | (34.5) | (15.2) | (62) |

The above results indicate that the commercially available tile adhesive membranes have very low shear strengths and do not meet the industry requirements. In contrast, the adhesive membrane of the present invention (last column) has very high strength and passed the industry standards. None of the commercial systems passed the creep test, heat resistance, whereas the adhesive membrane of the present invention held for greater than 24 hours without any tile movement. The commercial systems did not require a significant amount of force to pull the tile off the adhesive. The adhesive membrane of the present invention adhered greater than the board and the wall board delaminated.

I claim:

1. A method of applying a rigid tile to a tiling substrate comprising, providing an adhesive membrane comprising a polyolefin foam carrier having a first surface and an opposite second surface, wherein each of said first surface and said second surface are coated with a pressure sensitive adhesive;
adhering the adhesive membrane to either the tiling substrate or to the back surface of said tile via said pressure sensitive adhesive; and
pressing the back surface of said tile against the tiling substrate to adhere said tile to said tiling substrate with said adhesive membrane therebetween.

2. The method according to claim 1 wherein the polyolefin foam carrier has at least two material properties selected from the group of:
a compression strength @ 25% between 7 and 20 psi (48.3 and 137.9 kPa);
a tear resistance in the machine direction of more than 20 lb/in (3.57 kg/cm);
a tear resistance in a cross direction between 17 and 36 lb/in (3-6.4 kg/cm); and
a shore hardness A between 10 and 23.

3. The method according to claim 2 wherein the polyolefin foam carrier has a tear resistance in the machine direction of more than 20 lb/in (3.57 kg/cm) and not more than 50 lb/in (4.5-9 kg/cm).

4. The method of applying a rigid tile to a tiling substrate of claim 1 wherein the polyolefin foam carrier is a fine cell, crosslinked foam with a density between 2 and 20 lb/ft³ (32 to 320 kg/m³).

5. The method of applying a rigid tile to a tiling substrate of claim 1 wherein the foam carrier has a thickness of about 0.02 in (0.051 cm) to about 0.10 in (0.254 cm).

6. The method of applying a rigid tile to a tiling substrate of claim 1 wherein the foam carrier has a thickness of about 0.03 in (0.076 cm) to about 0.09 in (0.23 cm).

7. The method of applying a rigid tile to a tiling substrate of claim 1 wherein the pressure sensitive adhesive coated on each of said first surface and said second surface of the polyolefin foam carrier has a thickness of about 1.5 to 6.0 mils (0.0038 cm to 0,0152 cm).

8. The method of applying a rigid tile to a tiling substrate of claim 1 wherein the pressure sensitive adhesive coated on said first surface of the foam carrier has a thickness of about 2.5 to 6.0 mils (0.0063 cm to 0.0152 cm), and the pressure sensitive adhesive coated on said second surface of the foam carrier has a thickness of about 1.5 to 3.5 mils (0.0038 cm to 0.0089 cm).

9. The method of applying a rigid tile to a tiling substrate of claim 8 wherein the pressure sensitive adhesive coated on the first surface is adhered to the back surface of said tile, and the pressure sensitive adhesive coated on the second surface is adhered to the tiling substrate.

10. The method of applying a rigid tile to a tiling substrate of claim 1 wherein the shear strength of said adhesive membrane is at least 136.150 psi (344.7 kPa).

11. A construction substrate, wherein said construction substrate comprises a rigid tile or a tiling substrate, said construction substrate having an adhesive membrane adhered to a surface thereof, wherein the adhesive membrane comprises a polyolefin foam carrier having a first surface and an opposite second surface, wherein each of said first surface and said second surface are coated with a pressure sensitive adhesive, wherein the polyolefin foam carrier is a fine cell, crosslinked foam with a density between 2 and 20 pcf (32 to 320 kg/m³) and has at least two material properties selected from the group of:
a compression strength @ 25% between 7 and 20 psi (48.3 and 137.9 kPa);
a tear resistance in the machine direction of more than 20 lb/in (3.57 kg/cm);
a tear resistance in a cross direction between 17 and 36 lb/in (3-6.4 kg/cm); and
a shore hardness A between 10 and 23.

12. The construction substrate of claim 11 wherein the foam carrier has a thickness of about 0.02 in (0.051 cm) to about 0.10 in (0.254 cm).

13. The construction substrate of claim 11 wherein the foam carrier has a thickness of about 0.03 in (0.076 cm) to about 0.09 in (0.23 cm).

14. The construction substrate of claim 11 wherein the pressure sensitive adhesive coated on each of said first surface and said second surface of the polyolefin foam carrier has a thickness of about 1.5 to 6.0 mils (0.0038 cm to 0.0152 cm).

15. The construction substrate of claim 11 wherein the pressure sensitive adhesive coated on said first surface of the foam carrier has a thickness of about 2.5 to 6.0 mils (0.0063 cm to 0.0152 cm), and the pressure sensitive adhesive coated on said second surface of the foam carrier has a thickness of about 1.5 to 3.5 mils (0.0038 cm to 0.0089 cm).

16. The construction substrate of claim 15, wherein said construction substrate is a rigid tile, wherein the pressure sensitive adhesive coated on the first surface of the foam carrier is adhered to the back surface of said rigid tile, and wherein the pressure sensitive adhesive coated on the second surface of the foam carrier is covered with a removable release film.

17. The construction substrate of claim 15, wherein said construction substrate is a tiling substrate, wherein the pressure sensitive adhesive coated on the second surface of the foam carrier is adhered to the surface of said tiling substrate, and wherein the pressure sensitive adhesive coated on the first surface of the foam carrier is covered with a removable release film.

18. The construction substrate of claim 11 wherein the shear strength of said adhesive membrane is at least 136.150 psi (344.7 kPa).

19. A double sided pressure sensitive adhesive membrane system, comprising a first pressure sensitive adhesive;
a second pressure sensitive adhesive;
a polyolefin foam carrier having a first side and a second side, said first side coated with said first pressure sensitive adhesive, said second side coated with said second pressure sensitive adhesive, said polyolefin foam carrier having a compression strength not less than seven pounds per square inch, said polyolefin foam carrier having a compression strength not greater than 20 pounds per square inch at 25%.

20. The membrane system of claim 19, wherein said first pressure sensitive adhesive is an acrylic pressure sensitive adhesive.

21. The membrane system of claim 19, wherein said second pressure sensitive adhesive is an acrylic pressure sensitive adhesive.

22. The membrane system of claim 19, wherein said first pressure sensitive adhesive has a thickness greater than said second pressure sensitive adhesive.

23. The membrane system of claim 19, wherein said polyolefin foam carrier is comprised of a olefin homopolymer and a olefin copolymer having at least 50 mole % of one olefin unit and a monomer copolymerizable with said olefin homopolymer and a blend of at least 50% by weight of said olefin homopolymer or copolymer with another polymer.

24. The membrane system of claim 19, wherein said polyolefin foam carrier is comprised of a olefin homopolymer and a olefin copolymer having at least 70 mole % of one olefin unit and a monomer copolymerizable with said olefin homopolymer and a blend of at least 60% by weight of said olefin homopolymer or copolymer with another polymer.

25. The membrane system of claim 24 wherein said olefin homoploymer is a lower olefin having not more than six carbon atoms.

26. The membrane system of claim 24 wherein said olefin homopolymer is a lower olefin having not more than four carbon atoms.

27. The membrane system of claim 19, further comprising a release liner.

28. The membrane system of claim 19, further comprises a first release liner contacting said first pressure sensitive adhesive and a second release liner contacting said second pressure sensitive adhesive.

29. The membrane system of claim 28, wherein the release rate of said release liner's first side differs from the release rate of said release liner's second side.
